(19) United States
(12) Patent Application Publication
(10) Pub. No.: US 2023/0388597 A1
(43) Pub. Date: Nov. 30, 2023

(54) A 360 MEDIA-STREAMING NETWORK, CONTROLLER AND PROCESS

(71) Applicant: BESTSEAT 360 LIMITED, Grafton Auckland (NZ)

(72) Inventors: Craig Alexander MEEK, Birkenhead Auckland (NZ); David John BLAIR, Waitakere City Auckland (NZ); Fergus Hamilton MILNER, Whenuapai (NZ); Mark Alistair BARLOW, St Johns Auckland (NZ); Scott Thomas JUDSON, Point Chevalier Auckland (NZ)

(73) Assignee: BESTSEAT 360 LIMITED, Grafton Auckland (NZ)

(21) Appl. No.: 18/248,340

(22) PCT Filed: Oct. 6, 2021
(86) PCT No.: PCT/NZ2021/050169

§ 371 Date: Apr. 7, 2023

(30) Foreign Application Priority Data
Oct. 7, 2020 (AU) 2020903630
Nov. 16, 2020 (AU) 2020904199

(51) Int. Cl. H04N 21/472; H04N 21/218; H04N 21/222; H04N 21/235; H04N 21/437

(52) U.S. Cl. CPC H04N 21/47202; H04N 21/21805; H04N 21/222; H04N 21/2353; H04N 21/437

(57) ABSTRACT

An embodiment of the invention provides a process performed by a media streaming network, wherein the network is operable to stream media data from transmission modules to viewing interfaces and wherein the process comprises: requesting that the media server instantiate a media streaming service from which media can be streamed to one or more viewer interfaces; receiving input connection data from the media server, the input connection data carrying information to allow a transmission module to provide media to be streamed from the media streaming service; and transmitting to a transmission module input connection data to allow the transmission module to connect to the media service instantiated, wherein a transmission module is a module is operable to transmit media to the network to provide the transmission module.

### TECHNICAL FIELD

This invention relates to media streaming and particularly relates to networks for streaming media such as video. The present invention particularly relates to streaming of media captured by 360 cameras.

### BACKGROUND ART

Media streaming involves capturing media data, at cameras for example, and streaming the data to multiple viewers.

Transmitting media from events, such as sporting events is a well-established industry.

Developments in cameras, particularly in the quality of media captured by small and/or low-cost cameras, provide opportunities for enhanced experiences of viewers of events.

Developments in cameras that allow a range of directions of viewing, such as cameras referred to as 360 degree cameras, provide further opportunities for enhanced viewer experiences.

It would be of advantage to have improvements in the field of media-streaming networks which facilitate configuration and/or control of networks to capture and stream media, or at least to provide the public with a useful choice.

It would be of advantage to have improvements in the field of media-streaming networks which provide for control of the network to allow viewers at viewing interfaces to control media streaming to their respective interface, or at least to provide the public with a useful choice.

### DISCLOSURE OF THE INVENTION

Aspects of the invention provide a control module for a media streaming network, the control module operable to cause a media streaming service to be established, and to cause a module which transmits media to connect to said media streaming service established. The control module may associate an identifier used by the module which transmits the media with data which allows a viewer interface to connect to the media streaming service to receive streamed media. The control module may be operable to cause a number of media streaming services to be established and a number of modules which transmit media to connect to each connect to one of the media services established. A network comprising the modules which transmit media and the media streaming services may associate identifier data used by a given one of each transmission module with data which allows a viewer interface to connect to a given one of each media streaming service. A viewer interface may connect to a given media streaming service to receive media transmitted by a device by the viewer interface using the association of identifier data and data used to connect to a media streaming service.

According to one aspect of the present invention there is provided a control module for a media streaming network, wherein the network is operable to stream media data from transmission modules to viewing interfaces and wherein the control module is operable to:
communicate with a media server to request that the media server instantiate a media streaming service from which media can be streamed to one or more viewer interfaces,
receive input connection data from the media server, the input connection data carrying information to allow a transmission module to connect to the media stream to provide media to be streamed from the media streaming service; and
communicate with a transmission module which is operable to transmit media to the network to provide the transmission module with input connection data to allow the transmission module to connect to the media service instantiated.

The control module may be operable to receive device identifier data from a transmission module.

The control module may be operable to receive registration data from a transmission module.

The control module may be operable to receive data entered locally to the transmission module. Said data may be received at a user interface communicating with the transmission module. Said user interface may be an installer interface which allows personnel installing a transmission module and/or a camera communicating with the transmission module and/or a peripheral device of the transmission module. Said data may include context data carrying information recognisable by a viewer to use in selecting whether they want to view media transmitted from the transmission module and/or captured by a camera communicating with the transmission module and/or a peripheral device of the transmission module.

The control module may be operable to receive a device identifier from the transmission module and store the identifier to register the transmission module with the network.

The control module may be operable to receive a device identifier associated with a transmission module and store the identifier to register the transmission module with the network.

The control module may be operable to receive output connection data from the media module, the input connection data carrying information on an endpoint at which a viewer interface can connect to receive media streamed from the media streaming service.

The input connection data may carry information to allow a transmission module to provide media to the specific media streaming service instantiated at the request of the control module whereby a user interface which connects to the same media streaming service will receive media data streamed from a transmission module which has connected to the media streaming service using the input connection data for the specific media streaming service. The user interface may be a viewing interface at which a viewer is able to view media from one or more selected media streaming services. The control module may request multiple media streaming services be instantiated for respective multiple transmissions modules to provide respective multiple media streaming services for user interfaces to connect to receive media from any or each of the multiple transmission boxes.

The control module may be operable to perform said request for a media stream to be initialised subsequent to receiving a request from an administrator interface.

The control module may be operable to store data to associate a device identifier with input connection data.

The control module may be operable to store data to associate a device identifier with output connection data.

The control module may be operable to store data for multiple media streams to provide a candidate set of media streams to which a user interface can connect.

The control module may be operable to store data to associate context data with output connection data.

The control module may be operable to communicate with a web server which generates viewing interfaces wherein the control module provides output connection data allowing a viewing interface to connect to the media service instantiated at the request of the control module.

The viewing interfaces may be presented dependent on a subscription to the network.

The viewing interfaces may be web pages.

The viewing interfaces may be graphical user interfaces.

The control module may be operable to communicate with one or more media modules to request instantiation and/or initialisation of an additional media streaming service in response to the controller registering a second transmission module. The controller may be operable to communicate with a transmission module to transmit media to the network to provide the transmission module with input connection data for the additional media streaming service to allow the transmission module to connect to the media service instantiated.

The control module may be operable to communicate with one or more media modules to request instantiation and/or initialisation of a second media streaming service in response to the controller receiving data indicating growth in demand for viewing interfaces.

According to another aspect of the present invention there is provided a control module operable to associate data identifying a transmission module and/or a camera and/or a device and/or personnel with data identifying a media stream provided by a media module whereby said association of data allows a web server to generate user interfaces which connect to an appropriate media stream to display media data provided by the transmission module and/or a camera and/or a device and/or personnel wherein said connection is in response to a control at the viewer interface made in response to the display of data identifying the transmission module and/or devices and/or a camera and/or a device and/or personnel associated with the transmission module.

According to another aspect of the invention there is provided an administration interface operable to configure a web server to provide a viewing interface which allows selection of one or more media streams by selection of data identifying a transmission module and/or a camera and/or a device and/or personnel. The administration interface may be generated by a second web server.

According to one aspect of the present invention there is provided a process carried out by a control module for a media streaming network, wherein the network is operable to stream media data from transmission modules to viewing interfaces and wherein the process comprises the steps of:
communicating with a media server to request that the media server instantiate a media streaming service from which media can be streamed to one or more viewer interfaces,
receiving input connection data from the media server, the input connection data carrying information to allow a transmission module to connect to the media stream to provide media to be streamed from the media streaming service; and
providing the transmission module with input connection data to allow the transmission module to connect to the media service instantiated.

Input connection data may be made available at an interface associated with a transmission module.

Aspects of the present invention provide a transmission module which is operable to transmit media data provided by a camera or other sensor associated with the transmission module to transmit media from a given location and/or event and/or situation within the location or event, wherein the transmission module is operable to receive data which allows access to a media streaming service to provide media for the steaming service to stream, and wherein the transmission module is operable to transmit the media data using the received data. The transmission module may be operable to communicate with a network to register with the network. The transmission module may be operable to communicate with the network using one or more device identifiers.

According to one aspect of the present invention there is provided a transmission module operable to provide media data to be streamed, wherein the transmission module module is operable to:
receive input connection data carrying information to allow a transmission module to connect to a media service to provide media to be streamed from the media streaming service; and
to connect to the media service using the input connection data to provide the media service with data to be streamed by the media service.

The transmission module may be operable to provide a device identifier.

The transmission module may be operable to receive a device identifier.

According to one aspect of the present invention there is provided a process carried out by a transmission module to provide media data to be displayed at viewing interfaces, wherein the process comprises the steps of:
receiving input connection data carrying information to allow the transmission module to connect to the media service to provide media to be streamed from the media streaming service; and transmitting media to the media service using the input connection data to the media service instantiated to provide the media service with data to be streamed.

According to one aspect of the present invention there is provided a network which is operable to stream media, captured at two or more devices, to two or more subscriber devices, the network comprising:
one or more transmission modules each operable to transmit data captured at a device;
one or more media modules operable to provide one or more media streams each carrying media data received from a one of the one or more transmission modules;
one or more servers operable to provide the one or more viewer interfaces, each viewer interface operable to display one or more media streams each carrying media data provided by a selected one or more of the one or more transmission modules wherein said media provided by a selected transmission module is selectable dependent on one or more control inputs received at the viewer interface, wherein the one of more viewer interfaces provide one or more control elements to receive control inputs from the viewer;
one or more control modules operable to communicate with the media server to initiate a media stream provided by the media server, operable to communicate with one or more transmission modules to initialise each of the one or more transmission modules with connection data, and operable to initialise one or more transmission modules using connection data required by a transmission module to communicate with the media server to provide media for streaming,
wherein the one or more media streams displayed at the viewer interface are selected for display dependent on control inputs.

A subscriber device may be a general purpose device holding subscriber data to identify the device as a subscriber device. Subscriber data may allow the respective device to connect to the network.

The media provided may be media captured by one or more cameras having a selectable viewing direction and the one or more elements of the viewer interface may be operable to select a viewing angle within the media data. The one or more cameras may provide 360 camera media data. The one or more cameras may provide camera media data which covers a range of directions of view, such as a range of steradians, that exceeds a range of steradians that is displayed in a media frames, such as a video frame, in a 2D window at a viewer interface as one direction of view.

The viewer interface may be operable to run on a viewer device and to allow the viewer device to communicate with the media server to receive one or more media streams. Said one or more media streams received by the viewer device may be a media stream carrying media data provided by a transmission module selected dependent on one or more control inputs received at one or more control elements at the viewer interface. A transmission module may be associated with a camera and/or 360 camera and the one or more media streams received by the viewer device may be a media stream carrying media data provided by a camera selected dependent on one or more control inputs received at one or more control elements at the viewer interface.

The centralised control module may be operable to receive connection data from the media server.

The connection data provided by the media server may be data required by a transmission module to communicate with the media server to provide media for streaming at the one or more initiated media streams. The connection data may include a url for an endpoint of a media streaming service. The connection data may include an access code for an endpoint.

The centralised control module may be operable to store association data to associate media data provided by a given transmission box with a media stream carrying media data from said given media data.

The association data may be suitable to allow the viewer interface to select a media stream initiated wherein the media stream is selected dependent on one or more control inputs identifying a transmission module and/or given media data provided by a transmission module.

A process performed by a media streaming network, wherein the network is operable to stream media data from transmission modules to viewing interfaces and wherein the process comprises:
a media server instantiating a media streaming service from which media can be streamed to one or more viewer interfaces,
the media server providing input connection data, the input connection data carrying information to allow a transmission module to provide media to be streamed from the media streaming service; and
a transmission module receiving input connection data to allow the transmission module to connect to the media service instantiated, wherein a transmission module is a module is operable to transmit media to the network to provide the transmission module.

The process may comprise a transmission module providing context data carrying information recognisable by a viewer as providing context for the media to be transmitted by the transmission module and/or a camera. The context data may identify an event. The context data may identify an item of apparatus. The context data may identify a position on an item of apparatus. The context data may identify a participant.

The transmission module may register with the network using a device identifier.

The process may comprise storing data associating context data for a given transmission module and/or camera and/or peripheral device with data used to access media streamed from a media streaming service streaming media from the transmission module.

The process may comprise a web server generating data defining a viewer interface which displays media streamed from one or more transmission modules wherein the viewer interface displays context data and displays one or more user controls each associated with context data, receives control inputs at the one or more controls and connects to a media stream in response to a control inputs wherein said connection is made to a media stream to which a transmission module providing the context data associated with the given control.

The process may comprise instantiating an additional media streaming service from which media can be streamed to one or more viewer interfaces.

The process may comprise transmitting to an additional transmission module input connection data to allow the transmission module to connect to said additional media service instantiated.

The process may comprise a viewer interface receiving streamed media from one, other or both of the said media streaming service and said additional media streaming service.

The process may comprise a viewer interface connecting to each of the said media streaming services and said additional media streaming service selectively.

The process may comprise a viewer interface connecting to each of the said media streaming service and said additional media streaming service in response to control inputs made by a user at the viewer interface.

As used herein the terms ‘media data’ and ‘media’ refer broadly to any data captured and capable of transmission for use in media streaming and include videos, music, and photographs capable of being streamed and/or stored.

As used herein the term ‘media streaming’ is any process of streaming data.

As used herein the term ‘streaming’ is any process for transferring data so that it can be processed as a steady and continuous stream.

As used herein the term ‘run’ is used to refer broadly to software, code, scripts or instructions operating on a given platform, such as a browser to give one example.

As used herein the term ‘comprise’ is intended in the inclusive sense only, such that the phase ‘comprising’ a module, feature or step, for example, would not exclude comprising another module, feature or step.

As used herein the term ‘a’, ‘an’ and similar is intended in the inclusive sense only, such that the phase ‘a’ module, feature or step, for example, would not exclude comprising another module, feature or step.

As used herein the term ‘service’ is intended to refer broadly to a service provided by a computing system or software system, including but not limited to cloud computing services.

### BRIEF DESCRIPTION OF THE DRAWINGS

Example embodiments of the invention are now discussed with reference to the drawings in which:

FIG. 1 shows a network operable to stream media to one or more viewer interface;

FIG. 2 shows a process of initialisation of transmission modules according to the same embodiment as FIG. 1;

FIG. 3 shows a process of media stream activation according to the same embodiment as FIG. 1; and

FIG. 4 shows a process of media stream control according to the same embodiment as FIG. 1.

### BEST MODES FOR CARRYING OUT THE INVENTION

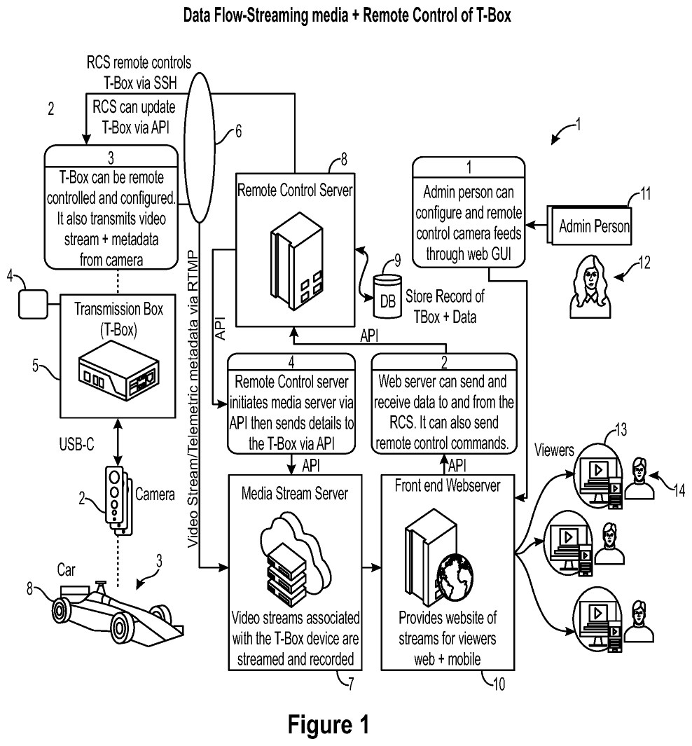

FIG. 1 shows a media streaming network 1 according to an embodiment of the invention. The media streaming network 1 of this embodiment streams data, specifically media, such as video, captured at multiple cameras for viewing at multiple subscriber viewer interfaces. In this embodiment, the media is streamed to given viewer interfaces controlled dependent on inputs made by a subscriber viewer at their respective viewer interface. The media streaming network 1 of this embodiment streams media as controlled also dependent on inputs by an administrator at an administrator interface. The media streaming network 1 of this embodiment is initialised and configured by a centralised control server.

The component modules of the media streaming network 1 will now be described.

The media streaming network 1 has one or more, but typically multiple, cameras 2 which capture photo and video data that may potentially be streamed to subscriber viewer interfaces 13. The media streaming network 1 of this particular embodiment also has one or more, but typically multiple, sensors (not shown) to capture data to be streamed to subscriber viewer interfaces. In this example the sensor data includes telemetry data.

In this particular embodiment the media streaming network 1 has a user interface 4, such as an installer interface or local interface 4. In this example the interface 4 allows a user to enter data locally. The user may be a person installing cameras or sensors, or possibly configuring cameras and sensors. In this example the data to be streamed includes context data which describes an event context for the camera installation. In one example the context data may name a competitor and position on their person or apparatus used, such as helmet or a place on a car. In this example the installer interface 4 is in communication with the transmission module 5.

FIG. 1 also shows a transmission module 5. The transmission module 5 is operable to communicate with a camera 2 to receive a data signal from the camera. In this embodiment the data signal from the camera 2 carries media such as video media. In this example, the transmission 5 is operable to communicate with the camera 2 also to control the camera 2. For example, the transmission module 5 may be able to control the camera to commence capturing media or to cease capturing media. In this example also the transmission module 5 is operable to receive data from devices (not shown) which sensor data or capture telemetry data.

The transmission module 5 of this embodiment is operable to compress media for transmission to the network 1. The transmission 5 shown in FIG. 1 is operable to communicate with the network 1 via a telecommunications network 6.

The transmission module 5 of this embodiment is operable to communicate with a streaming server 7. In this example, the transmission module 5 is able to receive media from multiple cameras 2 and/or sensors 3 to combine these into a ‘360 camera’ media stream apply a CODEC process to generate a compressed media stream and to transmit that media stream over the private network 6 to the streaming server 7.

The transmission module 5 is also operable to communicate with a centralised streaming network control module 8 over the private network 6 with processes described below. In this example, the control module is a server. In the embodiment shown in FIG. 1, the transmission module 5 is operable to communicate with the centralised streaming control server 8 to register the transmission module 5 with the control server 8, or with the network 1 more generally. This allows any transmission module 5, which may be provided and installed locally at an event, to become part of the network 1 and to participate in streaming media over the network 1.

The transmission module 5 of the embodiment of FIG. 1 also communicates with the server 8 to communicate data carrying information on a transmission module identifier and/or camera identifier and/or peripheral device identifier. The transmission module of this example also communicates context data. In this embodiment the context data is provided by installation personnel. In this example the context data is entered at the installer interface 4. In this example the context data provides context for the camera within a location or event. In this example the context data may identify a competitor and piece of apparatus in an event. For example, the context data may be a driver's name and identify that the camera is on their helmet.

The transmission module 5 is also able to communicate with the server 8 to receive data that allows it to connect to other parts of the network, such as to connect to the streaming server 7 to provide media. In this example the data received by the transmission module 5 from the control server 8 includes input connection data that allows the transmission module 5 to connect to a specific streaming service provided by the streaming server 7. In this example the input connection data carries information on an endpoint of a streaming service provided by the streaming server 7 to receive media and includes access data, specifically a RTMP code in this example.

The transmission module 5 is also able to receive configuration data from the server 8.

The telecommunications network 6 of this embodiment is a private network. In this example the network is a 5G network with a base-station local to a venue of an event to provide connectivity for the transmission boxes involved in the event. In this embodiment, the network 6 also registers with the control server 8 and/or the network 1 in general.

FIG. 1 also shows a streaming network database 9. The streaming network database 9 of this embodiment is a database under the control of the control server 8. This embodiment of the control server 8 uses the database 9 to store transmission module 5 identifiers of transmission modules registered with the network 1. The control server 8 also uses the database 9 to store input connection data used by transmission boxes to access the streaming server 7. The database 9 of this example stores data to associate an identifier of a given transmission module 5 with a URL for an input to the streaming server for a stream. In this embodiment also the database stores data to associate the transmission module 5 identifier with a URL of an API for an output media stream instantiated by the media server. This allows access to the stream provided by the server 7 that carries media provided by a given transmission module 5.

The database 9 embodiment of FIG. 1 is also operable to store media for video on demand access. In this embodiment this media stored for video on demand data is received from the streaming server 7 via the control server 8. The database 9 of FIG. 1 is also operable to store configuration data used to configure the transmission modules 5 and connected cameras 2 and peripheral devices 3.

The network 1 of FIG. 1 has a user interface server 10. In this embodiment the server 10 is a web server using web protocols known to the reader to generate web pages at urls provided. The web server 10 is operable to generate a user interface 11 for administration personnel, which may be recognised by the reader as an administration interface 11. The administration interface is operable to receive control inputs from the administrator and receive configuration data. These inputs allow configuration data to be input to the network 1. Control inputs at the administrator interface allow an administrator to enter configuration data for given transmission modules 5. The administration interface 11 also allows an administrator to prompt the database 9 to send the configuration data to the control server 8 and to prompt the control server 8 to transmit configuration data to transmission modules 5.

The administration interface 11 also allows an administrator to configure viewer interfaces 13. In one example, control inputs at the administration interface 11 configure which specific feeds from a set of feeds from transmission modules 5 a viewer is able to select for viewing at their respective viewing interface 13. The reader may recognise this as an administrator being able to curate 360 camera video feeds that are selectable and otherwise controllable by a viewer at viewer interfaces 13. The reader may recognise this curation as control of an aspect of the network 1.

The server 10 generates data for a number of the graphical user interfaces 13 at which viewers can view and control media streamed from various cameras 2 and/or peripheral devices three connected to various transmission modules 5. This embodiment the viewer interface 13 is a graphical user interface using any suitable windowing system known to the reader. In this embodiment the viewer interfaces 13 are viewed using browser software at a viewer device. In this embodiment also a viewer interface 13 requires a subscription and accesses the web server 10 by methods known to the reader.

In the embodiment of FIG. 1, the viewer interface 13 is customisable at both the administration interface 11 and at viewer interface 13.

The viewer interface 13 this embodiment displays context data which carries information on the context of a given camera 2, peripheral 3 and/or transmission module 5. For example, the context data may carry information on the identity of a participant in an event, such as the name of the event, driver, car or team. The viewer may use the context data, or information carried, to select a given media streaming service provided by the streaming server 7. The media streaming service streams a camera feed, for example, from a given transmission module 5 dependent on selections and/or controls made by a viewer at their respective viewer interface to 13.

In this example, the viewer interface 13 is provided by the web server 10. In this example also, the viewer interface to 13 allows selection and/or initiation of video-on-demand data to be viewed. In this example, the viewer interface 13 stores demand access data to allow video on demand to be received from a database. This access data may include a URL of the database API, commands defined for the API and data required to access the video on demand data.

In the embodiment of FIG. 1, the viewer interface 13 is operable to connect to multiple streaming services provided by the streaming server 7 at multiple API endpoints and is operable to display and/or allow the viewer to select streams from a candidate set of media streams. The candidate set is typically curated by control inputs at the administrator interface 11 provided for an administrator 12. In one example, a viewer interface 13 allows the viewer to select from a set of available 360 camera media streams from multiple cameras mounted on each of a number of cars in a race. For example, a viewer may select a camera mounted on an aerofoil on a car driven by the same driver and select a helmet camera of another driver. In this embodiment also, the user interface 13 allows the viewing direction from the 360 camera to be selected or controlled by the viewer. For example, a viewer may change the direction of viewing from a given 360 camera and may control what portion of a full 360 camera media feed appears on a two-dimensional window in a given viewer interface to 13. A 360 camera may provide media capturing images and video from a 2π steradian range of directions and a 2-dimensional window at the viewer interface 13 that covers a subset of those steradians. The viewer interface of this example allows the viewer to move the viewing angle within the full range of media captured by the 360 camera.

The media server 7 shown in FIG. 1 is operable to instantiate a number of media streaming services (not shown). In the embodiment shown the media server 7 is able to communicate with the control server 8 to receive requests to instantiate a new streaming service at the request of the control server 8. In this embodiment also the media server 7 is operable to generate access data for media to be used as an input to the media service. In this embodiment this includes a URL for an endpoint of the media streaming service and includes an RTMP code. The media server 7 of this embodiment is operable to communicate this input media access data to the control server 8.

The media server 7 of the embodiment shown in FIG. 1 is also able to communicate with a number of viewer interfaces 13. This embodiment the media server seven provides a URL for an API endpoint for each media stream. In this example, a media stream provides 360 camera streamed data for a single camera 2, such as one of the cameras connected to a single transmission module 5. Viewer interfaces 13 are able to connect to the endpoint to receive the 360 media data stream for that given camera, for example. In one example the viewer interface 13 displays context data used by a viewer to select a given camera, for example. The viewer interface 13 receives control inputs from the viewer which allows the viewer to select, or deselect, the given camera. Output access data provided by the Web server 10 allows the viewer interface to connect to the appropriate media stream to have a stream available for display at a window of the viewer interface 13. In this example, the media streams the 360 camera stream within which a viewer can to navigate to select a portion, such as a number of steradians of the 360 camera stream to be viewed in a given window of the viewer interface to 13.

Various connectivity and operations of the control server 8 have been described above. Further connectivity and operations will now be described. The control server 8 of this embodiments is able to communicate with transmission boxes 5 over the private network 6. This allows it to receive an identifier for a transmission module 5, or connected device, and store that data using the database 9. The control server 8 is operable to communicate with the database 9 to store transmission module identifier data and to send input media stream access data provided by the server 7 to transmission modules 5.

The control server 8 of the embodiment of FIG. 1 is also operable to receive output media stream access data from the media server seven and store it with the database 9. The control server 8 of the embodiment of FIG. 1 is also operable to retrieve the video on demand access data from the database and send it to the Web server 10. As discussed above, the control server 8 is able to request that a new media stream is instantiated by the media server 7 to receive streaming service input access data and receive streaming service output access data.

The control server 8 is also operable to communicate with the web server 10 to receive configuration data input at an administrator interface. It is also operable to send data carrying information identifying a transmission module 5 to the web server 10. In this embodiment the control server 8 is also operable to request that the web server 10 instantiate an administration interface 11.

Example processes performed by the network 1 FIG. 1 will now be described. Reference will be made to the modules, servers, database and interfaces described and illustrated above with reference to FIG. 1.

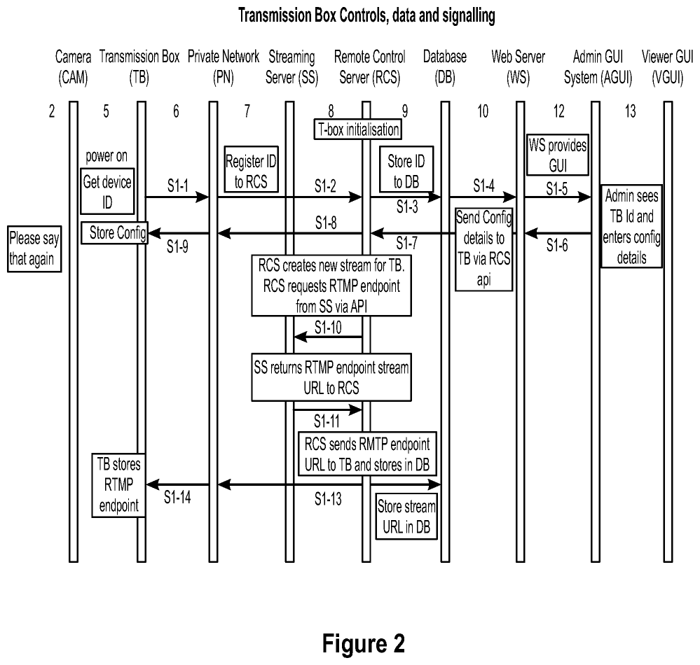

FIG. 2 depicts processes performed to initialise transmission modules 5. Although the processes are described with reference to transmissions, such as sending and/or receiving of transmissions, the reader will appreciate that processes required as precursors to these transmissions are also illustrated. The reader will appreciate that where reference to transmission or receipt of commands, requests, responses data and/or code the data are made these will be carried in transmissions, requests or responses using various formats and/or protocols and is known to the reader. For example, where a database request made using SQL the reader will understand that database request carried a restful request or known equivalent. It will also be understood by the reader where submission one module to another is made as a request, such is a restful request, was made in response to a request.

FIG. 1 illustrates a process carried out by modules of the network 1 to initialise a transmission module 5.

Installation personnel switch on a transmission module 5 which then transmits a device identifier to the private network 6 at step S1-1. In this example the device identifier is for a camera connected to a given transmission module 5. The private network 6 then transmits a registration request at S1-2 to the centralised streaming control server 8 to register the transmission module 5.

At S1-3 control server 8 transmits a database command to store the device identifier received from the transmission module 5 via the private network 6.

At S1-4 the database 9 transmits the device identifier of the transmission module 5 to the Web server 10.

In this example, the transmission of the device identifier causes the Web server 10 to generate an administration interface 11 in the form of a graphical user interface GUI, administrator GUI orAGUI 11. At S1-5, the device identifier is sent to the AGUI 11 for viewing by administration personnel.

At S1-6 the AGUI transmits configuration data to the web server 10 and transmits the configuration data to the control server 8 at S1-7.

The control server 8 transmits the configuration data to the private network 6 at S1-8 and onward at S1-9 to the transmission module 5 which stores the configuration data.

At S1-10 the control server 8 requests that the media server 7 instantiate a new media stream service to provision the network to stream 360 camera media from the transmission module 5 which has just been configured with configuration data received at S1-9. The control server 8 also requests from the media server 7 an RTMP endpoint. It does this using an API for the media server 7 describing endpoints and operations for control of the media server 7.

At S1-11 the media server 7 returns data carrying information on an RTMP endpoint and other information required by a transmission module 5 to connect to the newly instantiated streaming service to provide media as an input for the streaming service. This data may be referred as media service input access data, or input connection data. At S1-12 the media server 7 transmits the media service input access data along with data required by a viewer interface 13 to connect to an output of the same media streaming service.

At S1-13 the control server 8 transmits media service input access data to the private network 6 for onward transmission at S1-14 to the transmission module which then stores the data. In this embodiment, this data includes an RTMP endpoint for the media streaming surface 13 newly instantiated to receive media from the particular transmission module request of the control server 8.

The control server 8 with the database 9 processes (not shown) causes the database 9 to store data defining an association between device identifier, received from the transmission module 5, and access data for the newly instantiated streaming service.

At the end of the process illustrated with reference to FIG. 1 the network 1 has registered the transmission module 5, has instantiated a new streaming service for media from the transmission module, has stored access data which allows a module 5 to connect to a that streaming service, has stored output access data allowing a viewer interface 13 to connect to the media streaming service for that media and has stored an association between a device identifier and output data which allows a viewer interface to 13 to connect to the media streaming service for the transmission module 5.

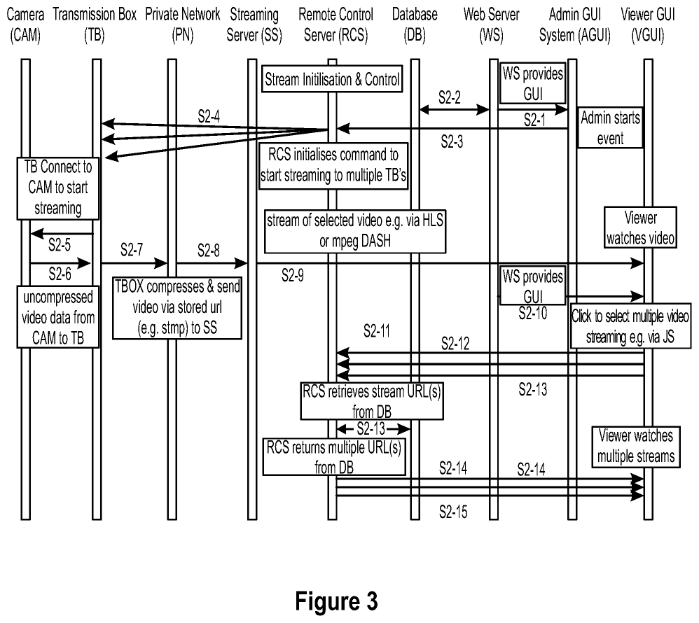

FIG. 3 depicts a process carried out by the network 1 to initialise and control stream camera to connected to a transmission module 5. For clarity, this example considers a single camera to connect to a single transmission module 5. However, in various embodiments multiple cameras are connected to a single transmission module 5.

Equivalent processes may be performed for initialisation and control of the streaming of telemetry data or other data provided by devices peripheral to a transmission module 5.

At is S2-1 the Web server 10 generates an Administration Graphical User Interface AGUI 11 which presents device identifier data for a mission module 5 retrieved at S2-2 from the database 9. The AGUI 11 displays data which allows an administrator to identify a given transmission module 5. The AGUI 11 receives control inputs indicating that the administrator would like one or more transmission modules 5 to be initialised and commence streaming.

This results in a request made at S2-3 to the control server from the AGUI 11. At S2-4 one or more requests are transmitted by the control server 2 to transmission modules 5 identified at the AGUI 11. In this example, requests are sent to multiple transmission modules 5.

The transmission modules 5 receive requests at S2-4 to connect to a respective camera 2 at S2-5, control the camera 2 to provide a camera feed at S2-6 and transmit media carrying the camera feed to the private network 6 and onward to the streaming service instantiated for each respective transmission module 5. In this example the camera feed received is uncompressed and the transmission module 5 compresses the camera feed to provide a compressed media stream at S2-7 to the network 6 and onward at S2-8 to the streaming service of the streaming server 7.

At S2-9 the streaming service of the media streaming server 7 is transmitted to a given viewer interface 13. In this example the viewing interface 13 is browser software running scripting software such as JavaScript™. The browser connects to an endpoint at the streaming server 7 for a specific streaming service which streams media from a selected transmission module 5. As described above the interface displays context data. A viewer can use the context data to make control inputs at the interface 13 to allow the interface to connect to an appropriate endpoint to receive 360 camera media streamed from the transmission module 5.

At S2-10 the Web server 10 provides a GUI, in the form of a web page in this example.

FIG. 3 depicts multiple requests at S2-11, S2-12 and S2-13 made to the control server 8 by the viewer interface 13 in response to control inputs at the viewer interface 13 to select streams going camera feeds that the viewer would like to view. The control server 8 makes a request received a response at S2-14 to the database 9 to retrieve appropriate URLs provided by the media server 7 specific streaming services 13 which stream media carrying specific camera feeds. The control server 8 returns to the viewer interface 13 the URLs retrieved from the database for specific streaming services 13 carrying specific camera feeds. The viewer interface 13 are then able to connect to the same specific URLs at S2-15, S2-16 and S2-17 to receive and display streams carrying camera feeds selected at the viewing interface is 13.

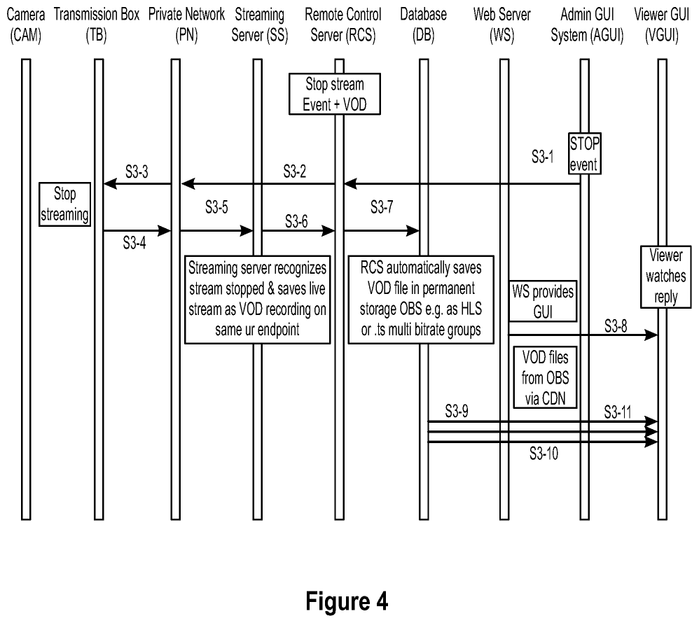

FIG. 4 depicts a process performed by the network 1 involving cessation of live streaming of camera feeds, storing video on demand data and access to video on demand data.

At S″-1 the AGUI 11 transmits request to the control server 8 in response to a control input at the AGUI 11 to stop streaming for a given event. The control server 8 transmits request to the private network 6 at S″-2 and onward to the transmission module 5 at S″-3 for the transmission module 5 to stop streaming.

At S″-4 the transmission module 5 transmits media to private network 6 and onward to the streaming server 7 at S″-5. The streaming server 7 recognises that the stream module 5 has stopped and performs an operation which saves data carrying live streaming media from the transmission module as video on demand data. This media has been received at and recorded at the same endpoint used by the transmission module 5 using input access data to a given streaming service. The control server 8 receives the recording at the streaming service off the streaming server 7 at S3-6 and transmits the video on demand file to the database 9 at S3-7 for permanent storage at the database or an object data storage service associated with the database 9.

At S3-8 the web server generates a viewer interface 13 with windows, displays and controls which allow the viewer to control receipt of video on demand. At S3-nine, S3-10 and S3-11 the database and/or an associated object storage service transmits video on demand to the viewer interfaces 13.

Further and additional embodiments will now be described.

Various embodiments may have any arrangement of cameras and/or sensors to transmission modules. Some embodiments may have any number of cameras arranged on a given apparatus, such as a car to name one of the wide range of examples, and may have any number of sensors arranged on the same apparatus and these may communicate with one or more transmission modules.

In various embodiments cameras are 360 cameras. In some embodiments the 360° cameras have multiple lenses and camera sensors, typically two for small footprint mobile or wearable applications and up to eight for fixed deployment.

In various embodiments electronics within the camera are controlled by a software application (App) or firmware running on the transmission module.

In various examples selected cameras are available for use by installers and/or event organisers provided that they meet compatibility requirements of the network.

In various examples 360° cameras have various control functions including resolution, orientation, exposure, shutter speed, and other control functions known to the reader. In various embodiments these functions are invoked and/or controlled by transmissions from the central controller 8. In some embodiments the controller 8 has a library of code and/or data and/or commends to use in transmissions to a transmission module to control an arbitrarily supplied camera. In various embodiments these functions are invoked and/or controlled by transmissions from the central controller 8. In some embodiments the transmission module has a library of code and/or data and/or commends to use to control an arbitrarily supplied camera. In other embodiments the control functions may be control in response to control inputs at the administration interface.

In some embodiments cameras perform stitching of an image using internal electronics and/or software and/or firmware. Other embodiments others require that stitching to be done in an external device such as a smartphone or Transmission module 5 to name two of many examples.

Various embodiments provide a media streaming network have any number of cameras or sensors known as suitable to the reader for a given application, such as a given type of event or an event with given resources. Some embodiments may have no sensors. Some embodiments may have no cameras.

Although FIG. 1 shows a single transmission box connected to a single camera, other implementations are also envisioned. In particular, it is envisioned that an event may have cameras installed on multiple devices, such as cars, and multiple transmission modules will be used. In these embodiments a transmission box will provide media data captured by one or more cameras. In various embodiments in any number of cameras and/or sensors may be integrated with a transmission module.

In various embodiments, any operations of any given camera known by the reader to be useful or necessary may be controllable by a transmission module or controllable by the AGUI 11.

In various embodiments a transmission module is operable to communicate with a user interface operable to allow an operator to enter data to be stored at the transmission module.

In various embodiments a transmission module is operable to generate a user interface operable to allow an operator to enter data to be stored at the transmission module. In some embodiments the user interfaces are a local user interface and allow a user to enter data at a location at which the transmission module is used, and may be referred to as a local user interface or installation user interface. In some embodiments the transmission module is operable to transmit this data to the network. In some embodiments the transmission module is operable to transmit this data to the controller 8. In some embodiments data received by the transmission module is included in context data displayed at viewer interfaces to allow a viewer to select a media stream carrying media transmitted by the respective transmission module.

In various embodiments a transmission module communicates with a camera or other device to control the camera or device by sending and/or receiving data, commands and user selected data or selections.

In various embodiments any number of cameras and/or sensors may be arranged to provide a compound camera and/or sensor. To give one of a wide range of examples cameras may be arranged to provide any defined range, or steradians, of viewing coverage at a given point in space. To give another of a wide range of examples cameras may be arranged to provide a compound camera which provides coverage of, say, front and back of a piece of apparatus such as a helmet to allow navigable viewing in front of and behind a competitor wearing a helmet for example.

In various embodiments a viewer purchases a subscription via a module providing a Cloud Services Marketplace.

In various embodiments cloud services automation creates media resources, web resources, and admin server/portal. These resources are then used to setup, manage, and run enhanced 360° video multiple-stream events anywhere in the world. In some embodiments the media resources may be implemented as a media streaming service.

In various embodiments media Resources transmit multiple 360° live video streams and recorded Video On Demand (VOD) streams to viewer devices (e.g. smartphones).

In some embodiments, media resources are generated to provide a load-balanced cluster in an Origin-Edge configuration with various media resources provisioned in different locations to fulfil cloud marketplace purchase parameters. In alternative embodiments media resources use a content delivery network where viewer stream latency is not critical.

In various embodiments, resources are initially provisioned to deliver a seamless multi-stream 360° video viewing experience to the anticipated viewing audience number and locations determined by parameters entered at time of cloud marketplace subscription by the client.

In various embodiments web resources provide viewers functionality to view the 360° video content, and is provisioned by means of a scalable app within the cloud scalability set so that as demand grows it upscales automatically to suit. In some embodiments the web resources are the viewing interfaces described and illustrated herein.

In various embodiments additional media resource are requested and initialized with as demand grows to near-capacity of initial provisioning. This may scale media resources. Various embodiments apply load-balance monitoring to prompt additional media resource requests. Various embodiments apply this scaling of media and web resources so that all viewers experience multi-stream video playback to a define quality of service.

In various embodiments viewers view and navigate multi-stream 360° video delivered via web server and media resources, including media streaming services described herein.

In various embodiments 360° video cameras are connected to transmission modules at an event venue. In various embodiments the network is agnostic of details of the cameras and/or transmission modules, other than a specification for operability, until a camera and or transmission module is registered with the network such as by the controller storing a device identifier to give one example. In various embodiments 360° video live streams are transmitted to media resources, such as a media service for example, for further distribution and recording by means of the transmission boxes.

In various embodiments an admin portal is provisioned by the cloud marketplace providing technical functions for non-technical operators. In some embodiments an admin portal is an administration interface as described and illustrated herein.

In various embodiments an admin operator can control and monitor cameras, transmission boxes, 360° video stream ‘health’, and layout the viewer web resources by means of a drag-and-drop WYSIWYG display.

In various embodiments personnel at administration portals or interfaces can also provision a live broadcast stream within the viewer page provided as a picture-in-picture (PIP) element on the page. In some embodiments this is done by means of a transmission module provisioned with broadcast-standard video input(s) e.g. SDI as known to the reader.

Various embodiments allow personnel at an administration interface to administer an event subscriber management system to limit the number of subscribers and viewing interfaces on the network. Various embodiments allow personnel at an administration interface to view and alter any interface, such as a viewer interface or web page. In various embodiments the administration interface may communicate with the web server directly or may communicate through the controller module 8.

In some embodiments a layout of a viewer interface, such as a web page, is shown in an edit screen at the administrator interface. This may be exactly as it appears when viewed by a viewer.

In some embodiments personnel at an administrator interface can edit the viewing interface, such as a web page.

For example, a remote data feed may exist from the event organisation's system which details all the competitors names in a particular event. These could show up in the assets list as numbered or named event data elements. Admin user could simply drag the event data element from the asset list into the clickable competitor list in the web page view and the GUI editor would auto-populate each name in the web page view list, allowing exactly correct changes to be made in seconds. Similar operation is used to alter any and all web pages including the creation of new pages and linking those to web page clickable elements or menu items.

In various embodiments transmission modules provide a media stream which carries information allowing photo or video data from a range of directions to be stitched together to provide photo or video data which a viewer can navigate within to change their aspect of viewing for example a viewer may adjust the direction from a camera they wish to view. The reader may recognise some of these embodiments is providing 360 camera media.

Various embodiments a module is various hardware, firmware and/or software or combination of these which provide operations known to the reader to provide the operability, capability and/or ability of the various modules described herein.

In various alternative embodiments a transmission module may receive ‘360 camera’ streams and may not need to generate these by stitching together two-dimensional camera streams.

In various embodiments the user interface 13 allows the viewing aspect from the 360 camera to be selected or controlled by the viewer.

The reader may appreciate that the in various embodiments the database may store only global identifiers used by an associated object storage service.

In various alternative embodiments a transmission module may apply any codec operation known as suitable to the reader for a given application or event. In some embodiments a transmission module may not form any codec operations.

In various alternative embodiments, a telecommunications network over which transmission modules communicate with other parts of the network may be any network known to the reader as suitable for given applications or events. Various embodiments may use a public telecommunications network.

In various embodiments the control server, such as 8 in FIG. 1, controls the database 9 using SQL commands. In other embodiments, any known communication language, protocols requests for sponsors known as suitable to the reader for given applications used by the server, or its equivalent, to use and/or control the database 9.

In the embodiment described above the web server is implemented with server software, or hardware dedicated to running server software, that can satisfy client requests on the World Wide Web. A web server can, in general, contain one or more websites. A web server processes incoming network requests over HTTP and several other related protocols. Various alternative embodiments use a user interface server using any known alternatives to web pages and/or protocols known to the reader as suitable for given applications. Various embodiments may rely on a browser to generate the user interface or may use alternatives to interfaces that rely on a browser and may include FTP and SCP to name two of many examples.

The administration interface and/or viewer interfaces have GUI elements using a windowing system known to the reader to display data to a user and allow the user to make control inputs. In one embodiment the GUI may include X-windows elements to display. Other embodiments use alternative GUI elements known to the reader to be suitable for given applications.

In alternative embodiments, a device identifier transmitted by a transmission module 5 to register the device may identify a given transmission module 5.

In various embodiments the controller 8 controls the database 9 to cause it to store data to associate various data used.

In various embodiments the data stored is a device identifier for a camera, peripheral device or a transmission module.

In various embodiments the data stored is input streaming access data that allows connection to a streaming service to provide data to the streaming service.

In various embodiments input streaming access data carries information on an endpoint. In various embodiments the input streaming access data carries information on an RTMP code.

In various embodiments the data stored is output streaming access data that allows connection to a streaming service to receive data from the streaming service. Various embodiments output streaming access data carries information on an endpoint.

In various embodiments data stored by the database associates context data with output streaming access data.

In various embodiments data stored by the database associates information on a device identifier of the device registered to the controller 8 with various combinations of one or more of the following: input streaming access data, output streaming access data, and context data.

In various embodiments the database 9 stores data to associate context data with an endpoint provided by the media server 7 for a streaming service that carries media selected by the viewer with control inputs made in response to viewing the context data.

In various embodiments a transmission module may be a transmission box.

As used herein module may be used to refer to any hardware, software or system of hardware and software used to provide the architecture or processes described. For example the term ‘module’ may be used to refer to transmission hardware 5, servers, databases, and user interfaces. Alternative aspects of the invention or embodiments of the invention may have alternative modules which divide and/or combine modules, software, hardware or systems of software or hardware described.

In various embodiments modules or apparatus illustrated may be implemented using processor readable code stored on processor readable media or storage to configure a processor to have features described with reference to network architecture and/or to perform steps in processes illustrated.

In various embodiments modules or apparatus illustrated may be implemented using processor readable code stored on processor readable media or storage to configure a processor, system of processors or network of processors to have features described with reference to network architecture and/or to perform steps in processes illustrated.

In various embodiments a network is any collection of modules known to the reader to be operable to transmit and receive data as illustrated herein.

In various embodiments data is stored to associate given data with other data. In one example data to be associated are stored in a relational database. In one example data to be associated are stored in a data table. In one example data to be associated are stored in a data structure defining an association. In one example further data is stored to define an association between data. In one example further data carrying information on pointers is stored to define an association between data.

In various embodiments modules or apparatus illustrated with reference to features of architecture and/or to steps in processes may be hardware configured according to code and data, such as VHDL or Verilog to name two examples of many.

In various alternative embodiments ‘data’ as used herein refers to data carrying information on the term, feature or concept referenced is association to the term ‘data’. For example, the term context data may refer in various embodiments to ‘data carrying information on ‘context’.

In various embodiments SDI is a standard known to the reader as serial digital interface. In other embodiments known alternative standards are used.

In various alternative embodiments a control module is operable to receive device identifier data associated with a transmission module. This may be received from the transmission module or from another module in the network. In various embodiments this is data entered locally to the transmission module, such as personnel installing a transmission module and/or a camera communicating with the transmission module and/or a peripheral device of the transmission module. In various other embodiments this is data provided by another module in the network. The identifier may be provided to the transmission module to use as an identifier. In other embodiments the identifier may be provided by the transmission module.

In various alternative embodiments a control module is operable to receive registration data associated with a transmission module. This may be received from the transmission module or from another module in the network. In various embodiments this is data entered locally to the transmission module, such as personnel installing a transmission module and/or a camera communicating with the transmission module and/or a peripheral device of the transmission module. In various other embodiments this is data provided by another module in the network.

In various embodiments the modules illustrated herein as operable with given functionality comprise an interface to provide that operability. In various embodiments an interface is any computer or software interface known to the reader as able to receive and/or provide data, code, or commands.

In various embodiments a control module is centralised in the sense that it provides control at a given centre of operations.

In various embodiments connection data may be provided for a transmission module directly to the transmission module. In other embodiments connection data may be provided at an interface locally to the transmission module. In other embodiments connection data may be provided at an interface accessible to personnel installing, configuring or connecting a transmission module to the network.

In various embodiments data illustrated by reference to given terms, such as input connection data for example, is data which carries information on the given terms.

In various embodiments a media service provides a media streaming service by instantiating the media streaming service. In various embodiments a media streaming server may instantiate multiple steaming services. In various embodiments the media server may communicate input connection data which allows connection to a specific streaming service instantiated.

In alternative embodiments an administrator interface 11 may receive and/or handle configuration data for transmission modules, while another interface receives control inputs to configure viewer interfaces.

In alternative embodiments an administrator interface may be provided by a module separate from the centralised control module 8. In various embodiments the configuration data may be sent to transmission boxes by modules other than the controller module 8.

In alternative embodiments a media server may receive some or all of the input connection data. In some embodiments this data may be received from the controller module.

In various alternative embodiment operations described above for the purpose of illustration as being performed by a given module may be performed by another module under the control or at the request of the module illustrated. In one example embodiment storage of data by the control module 8 to associate i) output connection data, that allows a viewer interface to receive media from a streaming service, and ii) device identifier data that identifies a transmission box and/or camera is implemented by the data being stored by another module at the request of the control module.

In various embodiments identifier data may be used to identify a camera, sensor or peripheral device rather than a transmission module. In various embodiments identifier data are used to identify each or any of cameras, sensors peripheral devices and/or transmission modules. In various embodiments a viewer interface may be able to connect to streaming services associated with given cameras, sensors or peripheral devices.

In various embodiments communication by a transmission module with the network includes transmission of media.

In various embodiments modules, servers and other parts of the architecture describe are implemented using computing services which provide computing resources which communicate by receiving requests and generating responses at endpoints defined by an application programming interface (API). The endpoint may be described by uniform resource locators (url). Various embodiments may implement services as cloud computing services, virtual machine services or local computing resources.

Some embodiments of the present invention provide a control server operable to communicate with the media server to instantiate a media stream, operable to communicate with a transmission module to configure the transmission box to connect to the media server such that the instantiated media stream carries media data transmitted by the transmission module.

In various embodiments a subscriber device is a device holding subscription data which allows the device to access a network by validating a subscription. In various embodiments the device has subscriber status. In other embodiments software running on the device has subscription status. In other embodiments a user of the device has subscription status.

Various embodiments provide a control server operable to associate data identifying a transmission module and/or a camera and/or a device and/or personnel with data identifying a media stream provided by a media server whereby said association of data allows the web server to connect to an appropriate media stream to display media data provided by the transmission module wherein said connection is in response to a control at the viewer interface made in response to the display of data identifying the transmission module and/or devices and/or a camera and/or a device and/or personnel associated with the transmission module.

Various embodiments provide an administration interface operable to configure the web server to provide a viewing interface which allows selection of one or more media streams by selection of data identifying a transmission module and/or a camera and/or a device and/or personnel.

In various embodiments a request made by a module is made using a command.

In various embodiments input connection data may be made available at an interface associated with a transmission module and/or camera and/or peripheral device. In various embodiments input connection data is provided at a user interface associated with a transmission module and/or camera and/or peripheral device. In various embodiments input connection data may be made available at a storage interface accessible by a transmission module and/or camera and/or peripheral device. In some embodiments the input connection data may be available to transmission module and/or camera and/or peripheral device by queries using an identifier. For example, identifiers and input connection data may be available at a look-up table.

In various embodiment the control server, or an additional module, is able to communicate with transmission boxes and/or cameras to control the transmission boxes. In various embodiments the cameras, sensors or peripheral devices associated with the transmission box are controlled by the transmission box. In various embodiments the network has a remote control module operable to control transmission boxes, cameras, sensors and peripheral devices remotely. In various embodiments the remote control module provides centralised remote control for transmission modules, and/or cameras and/or sensors and/or peripheral devices. In various embodiments the remote control and/or centralised remote control is provided by the control module, such as exemplified by control module 8. In various embodiments remote control of for transmission modules, and/or cameras and/or sensors and/or peripheral devices is provided by a separate module. In various embodiments that separate module is under the control of the control module 8. In various embodiments that separate module is controlled via the administration interface 11.

In various embodiments the transmission module may be provided with input connection data to connect with a media service in an initialisation process. In various embodiments a transmission module may be initialised by being provided with data to connect to a media stream.

In various embodiments context data may be read from a transmission module and/or camera and/or peripheral device. In various embodiments context data may be transmitted to the web server. In various embodiments a media streaming network control module stores data to associate context data with output connection data for a media stream. In various embodiments a media streaming network control module provides the web server with context data.

Various embodiments provide a network operable to stream media to one or more viewer interfaces, the network comprising:
one or more transmission modules operable to provide media data;
one or more media modules operable to provide one or more media streams each carrying media data received from a transmission module;
one or more web servers operable to provide the one or more viewer interfaces each viewer interface operable to display one or more media streams carrying media data provided by a selected one or more of the one or more transmission modules wherein said media provided by a selected transmission module is selectable dependent on one or more control inputs received at the viewer interface, wherein the one of more viewer interfaces provide one or more control elements to receive control inputs from the viewer;
one or more central control modules operable to communicate with the media server to initiate a media stream provided by the media server, operable to communicate with one or more transmission modules to initialise each of the one or more transmission modules with connection data, and operable to initialise one or more transmission modules using connection data required by a transmission module to communicate with the media server to provide media for streaming,
wherein the one or more media streams displayed at the viewer interface are selected for display dependent on control inputs.

The media provided may be media captured by one or more cameras having a selectable point of view and the one or more elements of the viewer interface may be operable to select a point of view within the media data. The one or more cameras may provide 360 camera media data.

The viewer interface may be operable to run on a viewer device and to allow the viewer device to communicate with the media server to receive one or more media streams. Said one or more media streams received by the viewer device may be a media stream carrying media data provided by a transmission module selected dependent on one or more control inputs received at one or more control elements at the viewer interface. A transmission module may be associated with a camera and/or 360 camera and the one or more media streams received by the viewer device may be a media stream carrying media data provided by a camera selected dependent on one or more control inputs received at one or more control elements at the viewer interface.

The centralised control module may be operable to receive connection data from the media server.

The connection data provided by the media server may be required by a transmission module to communicate with the media server to provide media for streaming at the one or more initiated media streams.

The centralised control module may be operable to store association data to associate media data provided by a given transmission box with a media stream carrying media data from said given media data.

The association data may be suitable to allow the viewer interface to select a media stream initiated wherein the media stream is selected dependent on one or more control inputs identifying a transmission module and/or given media data provided by a transmission module.

Various embodiments provide a centralised control module operable to:
communicate with one or more transmission modules operable to provide media data;
communicate with one or more media modules operable to provide one or more media streams each carrying media data received from a transmission module;
communicate with one or more web servers operable to provide the one or more viewer interfaces each viewer interface operable to display one or more media streams carrying media data provided by a selected one or more of the one or more transmission modules wherein said media provided by a selected transmission module is selectable dependent on one or more control inputs received at the viewer interface, wherein the one of more viewer interfaces provide one or more control elements to receive control inputs from the viewer, wherein the one or more central control modules may be further operable to communicate with the media server to initiate a media stream provided by the media server, operable to communicate with one or more transmission modules to initialise each of the one or more transmission modules with connection data, and operable to initialise one or more transmission modules using connection data required by a transmission module to communicate with the media server to provide media for streaming,
wherein the one or more media streams displayed at the viewer interface are selected for display dependent on said control inputs.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A network which is operable to stream media captured at a plurality of media capture devices to a plurality of viewer devices, the network comprising:
a plurality of transmission modules each operably connected to and configured to receive data captured by one or more media capture devices and to transmit said data to one or more media servers;
one or more media servers operable to provide a plurality of media streams each carrying data received from one or more transmission modules;
one or more web servers operable to receive a plurality of media streams from one or more media servers and provide a plurality of viewer interfaces, wherein each viewer interface is operable to display one or more of the media streams on a viewer device, wherein the plurality of viewer interfaces each provide control elements configured to receive control inputs from a viewer, and wherein said one or more media streams are selectable for display on the viewer interface based on said control inputs; and
one or more control modules operably connected to at least the plurality of transmission modules and the one or more media servers, the one or more control modules operable to:
communicate with each media server to instantiate a media stream from the media server to one or more of the web servers,
communicate with each transmission module to initialise communication between the transmission module and one or more of the media servers, wherein each communication between a transmission module and a media server is provided with connection data relating to the specific transmission module and media server,
receive context data provided locally to each transmission module, the context data carrying information recognisable by a user as relating to the context of data transmitted by a transmission module within a location or event, wherein the context data is associated with and transmitted alongside a corresponding media stream, and
store association data associating the context data with corresponding connection data, wherein each media stream is associated with said context data based on said association data; and
wherein each control element corresponds to a media stream and each media stream is displayed with its associated context data to allow a viewer to select a media stream on the viewer device based on said context data.

2. A control module for a media streaming network, wherein the network is operable to stream media data captured at a plurality of media capture devices to a plurality of viewer devices, wherein the control module is operable to:
communicate with a transmission module to initialise communication of data captured by one or more media capture devices with a media server, wherein each communication between a transmission module and a media server is provided with connection data relating to the transmission module and media server,
communicate with the media server to request that the media server instantiate a media stream to one or more viewer interfaces provided on one or more of the viewer devices, the media stream carrying at least said data received from the transmission module;
receive context data provided locally to the transmission module, the context data carrying information recognisable by a user as relating to the context of data transmitted by a transmission module within a location or event, wherein the context data is associated with and transmitted alongside a corresponding media stream; and
store association data associating the context data with corresponding connection data, wherein each media stream is associated with said context data based on said association data.

3. The control module of claim 1 further operable to receive device identifier data from a transmission module.

4. The control module of claim 1 or claim 2, further operable to receive registration data from a transmission module.

5. The control module of any preceding claim further operable to receive data entered locally to a transmission module, said data received at a user interface communicating with the transmission module, and including the context data.

6. The control module of any preceding claim further operable to receive a device identifier associated with a transmission module and store the identifier to register the transmission module with the network.

7. The control module of any preceding claim further operable to receive output connection data from a media server, the connection data carrying information on an endpoint at which a viewer interface can connect to receive media streamed from the media streaming service, and to store association data associating the connection data with the output connection data.

8. The control module of any preceding claim further operable to request multiple media streaming services be instantiated for respective multiple transmissions modules to provide respective multiple media streaming services for user interfaces to connect to receive media from any or each of the multiple transmission modules.

9. The control module of any preceding claim, further operable to store data to associate a device identifier with connection data.

10. The control module of any preceding claim, further operable to store data to associate a device identifier with output connection data.

11. The control module of any preceding claim further operable to store data for multiple media streams to provide a candidate set of media streams to which a user interface can connect.

12. The control module of claim 2, further operable to communicate with a web server configured to provide the one or more viewer interfaces, each viewer interface operable to receive and display the media stream on a viewer device, wherein the plurality of viewer interfaces provide control elements configured to receive control inputs from a viewer, and wherein said one or more media streams are selectable for display on the viewer interface based on said control inputs, wherein the control module provides connection data allowing a viewer device to connect to the media stream instantiated at the request of the control module.

13. A process performed by a media streaming network, wherein the network is operable to stream media data captured at a plurality of media capture devices to a plurality of viewing interfaces provided on viewer devices, and wherein the process comprises:
a media server receiving data from a transmission module operably connected to the one or more of the media capture devices,
a control module instantiating a media stream at the media server from which media can be streamed to one or more of the viewer interfaces, the media stream carrying data received from the transmission module,
the media server providing input connection data to the control module, the input connection data allowing the transmission module to transmit data to the media server;
the transmission module receiving the input connection data from the control module, the input connection data configured to allow the transmission module to connect to the media server,
the transmission module providing context data carrying information recognisable by a viewer as relating to the context of data transmitted by a transmission module within a location or event, wherein the context data is associated with and transmitted alongside a corresponding media stream, and
the control module storing association data associating the context data with corresponding input connection data, wherein each media stream is associated with said context data based on said association data.

14. The process of claim 13 comprising the transmission module registering with the network using a device identifier.

15. The process of claim 13 comprising a web server generating data defining a viewer interface which displays media data streamed from one or more transmission modules wherein the viewer interface displays the context data and one or more user controls each associated with the context data, receives one or more control inputs at the one or more user controls, and connects to a media stream in response to the control input(s), wherein said connection is made to a media stream based on the association data which links the displayed context data to a media stream.

16. A process performed by media streaming network, wherein the network is operable to stream media data captured at a plurality of media capture devices to a plurality of viewing interfaces provided on viewer devices, and wherein the process comprises:
a control module requesting that a media server instantiate a media stream from which media can be streamed to one or more of the viewer interfaces, the media stream carrying data received from a transmission module operably connected to the one or more of the media capture devices,
the control module receiving input connection data from the media server, the input connection data carrying information to allow the transmission module to transmit data to the media server; and
the control module transmitting to the transmission module the input connection data, the input connection data configured to allow the transmission module to connect to the media server,
the transmission module providing context data carrying information recognisable by a viewer as relating to the context of data transmitted by a transmission module within a location or event, wherein the context data is associated with and transmitted alongside a corresponding media stream, and
the control module storing association data associating the context data with corresponding input connection data, wherein each media stream is associated with said context data based on said association data.

17. The network of claim 1, further comprising an administration interface operable to configure the web server to provide the viewing interface(s) which allows selection of one or more media streams by selection of data identifying the data transmitted by a transmission.

18. The network of claim 17, wherein the administration interface is generated by the web server.
